(19) United States
(12) Patent Application Publication
(10) Pub. No.: US 2026/0183838 A1
(43) Pub. Date: Jul. 2, 2026

(54) UNSUPPORTED BIMETALLIC PARTICULATE MATERIAL

(71) Applicant: HERAEUS PRECIOUS METALS GMBH & CO. KG, Hanau (DE)

(72) Inventors: Milena KOVJENIC, Hanau (DE); Ana-Lucia MEZA-CHINCHA, Hanau (DE); Marie-Lena HARWARDT, Hanau (DE); Michael GOCK, Hanau (DE); Matthias HÖRTEIS, Hanau (DE); Christian IMGRUND, Hanau (DE)

(21) Appl. No.: 19/127,329

(22) PCT Filed: Nov. 1, 2023
(86) PCT No.: PCT/EP2023/080451

§ 371 Date: May 5, 2025

(30) Foreign Application Priority Data
Nov. 11, 2022 (EP) 22206906.4

(51) Int. Cl. B22F 1/00; B01J 23/89; B22F 1/05; B22F 9/30

(52) U.S. Cl. CPC B22F 1/09; B01J 23/89; B22F 1/05; B22F 9/30; B22F 2301/255; B22F 2304/058; B22F 2304/10

(57) ABSTRACT

A carrierless bimetallic particulate material comprising elemental metallic silver and elemental metallic ruthenium having an average particle size (d50) in the range of 1 to 100 μm, preferably 1 to 20 μm and comprising a silver: ruthenium weight ratio in the range of 1 to 2000 parts by weight of silver: 1 part by weight of ruthenium.

The invention relates to a carrierless bimetallic particulate material comprising elemental metallic silver and elemental metallic ruthenium and to an efficient method for its production.

EP 3 915 376 A1 discloses a hybrid material which can be used as an antimicrobial, antiviral and/or fungicidal additive and comprises particles each comprising at least one carrier material which is coated at least in part with at least two different metals. The metals are in electrically conductive contact with each other, at least with their respective surfaces. The first metal comprises at least one transition metal element which has a plurality of oxidation states and allows a change of oxidation states via catalytically active centers, for example ruthenium. The second metal, for example silver, comprises at least one electrically conductive silver semiconductor, the two metals forming half-elements that are short-circuited in the presence of water and oxygen.

The object of the invention was to provide a material which is highly antimicrobially effective, can be produced easily and efficiently and is based on a carrier material comprising elemental silver and elemental ruthenium.

The object can be achieved by providing a carrierless bimetallic particulate material comprising elemental metallic silver and elemental metallic ruthenium having an average particle size (d50) in the range of 1 to 100 μm, preferably 1 to 20 μm, and comprising a silver: ruthenium weight ratio in the range of 1 to 2000 parts by weight of silver: 1 part by weight of ruthenium, hereinafter also referred to simply as “carrierless bimetallic particulate material”.

The term “average particle size” used herein means the volume-average primary particle diameter (d50) determinable by means of laser diffraction. In this case, what is known as Equivalent Circular Area Diameter (ECAD) can advantageously be used as a measure of the particle diameter (cf. RENLIANG XU ET AL: “Comparison of sizing small particles using different technologies,” POWDER TECHNOLOGY, ELSEVIER, BASEL (CH), vol. 132, no. 2-3, Jun. 24, 2003(06-24-2003), pages 145-153). Laser diffraction measurements can be carried out using a corresponding particle size measuring instrument, for example a Mastersizer 3000 or Mastersizer 2000 from Malvern Instruments according to the wet determination process. In the wet determination process, a particulate sample can be dispersed in ethanol by means of ultrasound as part of the preparation of the sample.

The carrierless bimetallic particulate material according to the invention comprises particles consisting of silver particles provided with elemental ruthenium. It can also comprise silver particles, ruthenium particles and/or ruthenium particles provided with elemental silver.

However, the material consists at least mainly, for example ≥90 to 100 wt. %, of silver particles provided with elemental ruthenium; accordingly, the 0 to ≤10 wt. % portion can consist of silver particles, ruthenium particles and/or ruthenium particles provided with elemental silver. The carrierless bimetallic particulate material according to the invention does not comprise any carrier material whatsoever; beyond the silver particles provided with elemental ruthenium and the silver particles, ruthenium particles and/or ruthenium particles provided with elemental silver that may be present, the carrierless bimetallic particulate material according to the invention does not comprise any deliberately added material or substances whatsoever, in particular any material or substances that could be used as a carrier material; even vitamins, vitamin derivatives, ascorbic acid and ascorbic acid derivatives are not comprised either.

The elemental ruthenium of the silver particles provided is present on the outer surface of the silver particles and can, for example, form a discontinuous layer and/or small ruthenium particles (ruthenium islands); the silver particles themselves act as a carrier material. Scanning electron microscopy may be a suitable method for observing such morphological properties. The silver and the ruthenium are not alloyed, but are statistically distributed, and both noble metals are at least partially in contact with one another. It is clear to a person skilled in the art that the silver and the ruthenium on the surface of the carrierless bimetallic particulate material according to the invention can comprise silver species other than elemental metallic silver and ruthenium specied other than elemental metallic ruthenium—for example corresponding oxides, halogenides and/or sulfides. Such species can be produced unintentionally and inevitably as minor impurities during or subsequent to production, for example during storage, use or further processing of the carrierless bimetallic particulate material according to the invention.

The invention also relates to a method for producing the carrierless bimetallic particulate material according to the invention. In the method according to the invention, the carrierless bimetallic particulate material according to the invention can be obtained in the course of drying and thermolytic treatment, taking place under a non-oxidizing atmosphere, of an aqueous suspension comprising water, silver particles and at least one ruthenium precursor. Thermolytic treatment is a treatment at or above the thermolysis temperature, i.e. the minimum object temperature that ensures thermal decomposition of the ruthenium precursor(s) to form elemental ruthenium under a non-oxidizing atmosphere.

The term “non-oxidizing atmosphere” as used herein refers to a reducing or inert atmosphere. The term “reducing atmosphere” refers to an atmosphere consisting of a gas that has reducing properties, such as hydrogen and/or carbon monoxide, or to a gas mixture of a gas that has reducing properties with an inert gas, such as nitrogen, argon and/or carbon dioxide; the volume fraction of gas that has reducing properties within a gas mixture with inert gas can, for example, be in the range of 5 to 10 vol. %. The term “inert atmosphere” refers to an atmosphere consisting of an inert gas such as nitrogen, argon and/or carbon dioxide.

In the method according to the invention, silver particles and at least one ruthenium precursor are used.

The silver particles mentioned herein or the silver particles used as a starting material in the method according to the invention are those with an average particle size (d50), for example, in the range of 0.5 um to 50 um. The silver particles can have a variety of shapes, for example they can be spherical, substantially spherical, elliptical, ovoid, flake-shaped or have an irregular shape. The silver particles are expediently uncoated and they may comprise particles of pure silver (silver purity of at least 99.9 wt. %) and/or those of silver alloys containing up to 10 wt. % of at least one other alloying metal. Examples of suitable alloying metals are copper, gold, nickel, palladium, platinum and aluminum. Silver particles consisting of pure silver are preferred. Silver particles are commercially available. An example is the silver powder “Ag 300-01” from Heraeus Electronics. Similar powders are also available from other companies.

The ruthenium precursor(s) used in the method according to the invention are ruthenium compounds which can be thermally decomposed to form elemental ruthenium under a non-oxidizing atmosphere.

All ruthenium compounds which can be thermally decomposed to form elemental ruthenium under a non-oxidizing atmosphere can be thermolytically treated in the method according to the invention under a reducing atmosphere and in the process be thermally decomposed to form elemental ruthenium. Examples of ruthenium compounds which are suitable in this regard include ruthenium nitrosyl nitrate, ruthenium oxalate, ruthenium acetate and in particular ruthenium nitrosyl oxalate.

Some ruthenium compounds which can be thermally decomposed to form elemental ruthenium under a non-oxidizing atmosphere can be thermolytically treated in the method according to the invention even under an inert atmosphere and in the process be thermally decomposed to form elemental ruthenium. A person skilled in the art can easily determine such suitability of a ruthenium compound for thermal decomposition to form elemental ruthenium under an inert atmosphere, for example using thermogravimetry under an inert gas atmosphere. Examples of ruthenium compounds that are suitable in this regard include ruthenium oxalate, ruthenium acetate and in particular ruthenium nitrosyl oxalate.

The production method according to the invention comprises providing an aqueous suspension comprising water, silver particles and at least one ruthenium precursor, as well as drying and thermolytically treating the aqueous suspension under a non-oxidizing atmosphere. Drying and thermolytic treatment can be carried out sequentially or as a joint step.

In a first embodiment, the method according to the invention comprises the successive steps of:
(1) providing an aqueous suspension comprising water, silver particles and at least one ruthenium precursor,
(2) drying the aqueous suspension provided in step (1), and
(3) thermolytically treating the dried material obtained after completion of step (2) under a non-oxidizing atmosphere.

In a second embodiment of steps (2) and (3) carried out jointly, the method according to the invention comprises the successive steps of:
(1) providing an aqueous suspension comprising water, silver particles and at least one ruthenium precursor, and
(2+3) drying and thermolytically treating the aqueous suspension provided in step (1) under a non-oxidizing atmosphere.

In step (1) according to both embodiments of the method according to the invention, an aqueous suspension is provided, which comprises water, silver particles and at least one ruthenium precursor. The aqueous suspension can be in the form of a thin slurry or a pulp-like, paste-like or dough-like mass.

The aqueous suspension can be produced by adding the silver particles to an aqueous solution of the at least one ruthenium precursor and suspending them therein. The opposite addition sequence is also possible.

The weight proportion of the silver particles of the aqueous suspension provided in step (1) of the method according to the invention can be in the range of, for example, 5 to 60 wt. %.

The ruthenium weight proportion of the aqueous suspension provided in step (1) of the method according to the invention can be in the range of, for example, 0.5 to 20 wt. %. The aqueous suspension provided in step (1) of the method according to the invention is characterized by a weight ratio of the two noble metals, for example, in the range of 1 to 2000 parts by weight of silver: 1 part by weight of ruthenium and generally significantly in favor of the silver.

In addition to the silver particles and the ruthenium precursor(s), the aqueous suspension provided in step (1) of the method according to the invention generally comprises only water and optionally corresponding acid from the ruthenium precursor(s), i.e. said suspension consists at least substantially or preferably only of the silver particles, the ruthenium precursor(s) and water.

In step (2) according to the first embodiment of the method according to the invention, the aqueous suspension provided in step (1) is dried, i.e. water and any other volatile substances present are removed.

The aqueous suspension is concentrated to dryness by evaporation. Advantageously, the aqueous suspension is agitated during concentration, for example by stirring and/or shaking and/or rotation, i.e., rotation of the vessel or container containing the aqueous suspension. In general, heating and/or negative pressure are applied during concentration to remove water and any other volatile substances that may be present. During concentration, work can be carried out at a temperature in the range of 40 to 95° C., for example. The material obtained after dryness has been achieved can be comminuted if necessary.

In step (3) according to the first embodiment of the method according to the invention, the ruthenium precursor(s) are thermally decomposed to form elemental ruthenium. For this purpose, the material obtained after completion of step (2) and optionally comminuted (i.e. the dried, originally aqueous suspension obtained after completion of step (2)) is subjected to a thermolytic treatment under a non-oxidizing atmosphere. For this purpose, the material can be heated, either not in motion or in motion, to a thermolysis temperature, for example in the range of 150 to 1000° C., for example in a static furnace, a fluidized-bed reactor or a rotary kiln.

During step (3), the furnace chamber is expediently flushed with the gas comprising non-oxidizing properties; the gas flow can also serve to remove gaseous decomposition products. The non-oxidizing atmosphere can also be pressure-reduced.

In the combined step (2+3) according to a first variant of the second embodiment of the method according to the invention, the aqueous suspension provided in step (1) is dried and thermolytically treated under a non-oxidizing atmosphere. The aqueous suspension provided in step (1) can pass through, either in motion or not in motion, a temperature profile comprising a drying temperature and a higher thermolysis temperature within a furnace. This can be achieved by passage through a furnace with a temperature gradient comprising a drying temperature and a thermolysis temperature or by working in a furnace with a time-controlled heating or temperature program, which ensures a drying temperature first and then a thermolysis temperature. Examples of usable furnace types include static furnaces, fluidized-bed reactors and rotary kilns. In this way the aqueous suspension provided in step (1) can first be dried, i.e. water and any other volatile substances present can be removed, i.e. concentrated to dryness by evaporation. During concentration by evaporation, work can be carried out at a drying temperature in the range of 40 to 95° C., for example. After drying is complete, the ruthenium precursor(s) is/are thermally decomposed to form elemental ruthenium by immediately being heated further to the thermolysis temperature without intermediate cooling, for example in the range of 150 to 1000° C.; i.e. the dried material is subjected to a thermolytic treatment. This drying, as well as the thermolysis immediately thereafter, take place under a non-oxidizing atmosphere.

Also in the combined step (2+3) according to a second variant of the second embodiment of the method according to the invention, the aqueous suspension provided in step (1) is dried and thermolytically treated under a non-oxidizing atmosphere. The aqueous suspension provided in step (1) can be exposed, in motion or not in motion, to said thermolysis temperature, for example in the range of 150 to 1000° C., within a furnace. Examples of usable furnace types include static furnaces, fluidized-bed reactors and rotary kilns. The ruthenium precursor(s) are thermally decomposed to form elemental ruthenium. Drying and thermolysis occur practically in parallel or overlapping. Work is carried out under a non-oxidizing atmosphere.

After completion of step (3) according to the first embodiment or of step (2+3) according to both variants of the second embodiment of the method according to the invention and optionally subsequent comminution and/or classification, the carrierless bimetallic particulate material according to the invention is obtained.

The carrierless bimetallic particulate material according to the invention is characterized by a particularly strong antimicrobial effect, as can be determined in conventional inhibition zone tests or by determining the minimum inhibitory concentration from growth curves of microorganisms. In this respect, the invention also relates to the use of the carrierless bimetallic particulate material according to the invention provided as an additive for the antimicrobial treatment of metal surfaces; coating agents such as varnishes and other paints; plasters; molding compounds; plastics materials in the form of plastics films, plastics parts, or plastics fibers; textiles or in textile applications; synthetic resin products; ion-exchange resins; silicone products; cellulose-based products; foams; cosmetics; and many others.

The carrierless bimetallic particulate material according to the invention can also be used as a heterogeneous catalyst, for example in catalysis of the formation of antimicrobially active hydroxyl radicals in aqueous media permitting bacterial growth.

The carrierless bimetallic particulate material according to the invention can be used in the aforementioned applications as a dry powder, as a powder with a desired moisture content or as a suspension.

### EXAMPLE 1

### According to the Invention (Thermolytic Production of a Silver Powder According to the Invention Provided With Ruthenium Consisting of 80 wt. % Elemental Silver and 20 wt. % Elemental Ruthenium)

An aqueous suspension prepared from 5 g of silver powder (46.4 mmol Ag, silver powder “Ag 300-01” from Heraeus Electronics) and 21.55 g of ruthenium nitrosyl oxalate solution (ruthenium content 5.8 wt. %, 12.4 mmol Ru) was concentrated to dryness by evaporation using a rotary evaporator (90° C./300 mbar). The dry material was then calcined at 200° C. in a tube furnace for 21 hours under a nitrogen atmosphere and comminuted by means of an agate mortar. A silver content of 80.0 wt. % and a ruthenium content of 20.0 wt. % of the product (relative to 0 wt. % residual moisture) was determined by means of ICP-OES.

### EXAMPLE 2

### According to the Invention (Thermolytic Production of a Silver Powder According to the Invention Provided With Ruthenium Consisting of 80 wt. % Elemental Silver and 20 wt. % Elemental Ruthenium)

An aqueous suspension prepared from 5 g of silver powder (46.4 mmol Ag, silver powder “Ag 300-01” from Heraeus Electronics) and 93.98 g of ruthenium acetate solution (ruthenium content 1.3 wt. %, 12.4 mmol Ru) was concentrated to dryness by evaporation using a rotary evaporator (90° C./300 mbar). The dry material was then calcined at 800° C. in a tube furnace for 21 hours under a nitrogen atmosphere and comminuted with an agate mortar. A silver content of 80.0 wt. % and a ruthenium content of 20.0 wt. % of the product (relative to 0 wt. % residual moisture) was determined by means of ICP-OES.

### Testing for Antimicrobial Effect

In separate Erlenmeyer flasks, 30 mL of a culture of methicillin-resistant Staphylococcus aureus (MRSA) in tryptic soy broth (TSB) was adjusted to an optical density of 0.05. Different amounts of the silver powders provided with ruthenium from Examples 1 and 2 according to the invention were then weighed in in the range of 1 to 50 mg. The samples were incubated in a shaking incubator at 37° C. and 150 rpm. Within 6 hours, the optical density at a wavelength of 600 nm (OD600) was determined at hourly intervals. The inhibition of bacterial growth was indicated by a reduced increase in optical density compared to the control sample. An MRSA culture without the addition of an active antimicrobial substance served as the control sample. In the case of complete inhibition of bacterial growth, no increase in optical density was to be observed. This resulted in a minimum inhibitory concentration for the product from Example 1 according to the invention of 0.4 mg/mL and for Example 2 according to the invention of 1.6 mg/mL.

1. A carrierless bimetallic particulate material comprising elemental metallic silver and elemental metallic ruthenium having an average particle size (d50) in the range of 1 to 100 μm, preferably 1 to 20 μm, and comprising a silver: ruthenium weight ratio in the range of 1 to 2000 parts by weight of silver: 1 part by weight of ruthenium.

2. The carrierless bimetallic particulate material according to claim 1, consisting of ≥90 to 100 wt. % silver particles provided with elemental ruthenium and 0 to ≤10 wt. % silver particles, ruthenium particles and/or ruthenium particles provided with elemental silver.

3. A method for producing the carrierless bimetallic particulate material according to claim 1 by means of drying and thermolytic treatment, taking place under a non-oxidizing atmosphere, of an aqueous suspension comprising water, silver particles and at least one ruthenium precursor in the form of a ruthenium compound which can be thermally decomposed to form elemental ruthenium under a non-oxidizing atmosphere.

4. The method according to claim 3, wherein the silver particles are those having an average particle size (d50) in the range of 0.5 μm to 50 μm.

5. The method according to claim 3, wherein the non-oxidizing atmosphere is a reducing atmosphere, and wherein the at least one ruthenium precursor is selected from the group consisting of ruthenium nitrosyl nitrate, ruthenium oxalate, ruthenium acetate and ruthenium nitrosyl oxalate.

6. The method according to claim 3 wherein the non-oxidizing atmosphere is an inert atmosphere, and wherein the at least one ruthenium precursor is selected from the group consisting of ruthenium oxalate, ruthenium acetate and ruthenium nitrosyl oxalate.

7. The method according to claim 3, comprising the successive steps of:
(1) providing an aqueous suspension comprising water, silver particles and at least one ruthenium precursor,
(2) drying the aqueous suspension provided in step (1), and
(3) thermolytically treating the dried material obtained after completion of step (2) under a non-oxidizing atmosphere.

8. The method according to claim 3, comprising the successive steps of:
(1) providing an aqueous suspension comprising water, silver particles and at least one ruthenium precursor, and
(2+3) drying and thermolytically treating the aqueous suspension provided in step (1) under a non-oxidizing atmosphere.

9. The method according to claim 3, wherein the thermolytic treatment is carried out at or above a thermolysis temperature in the range of 150 to 1000 °C.

10. A use of a carrierless bimetallic particulate material comprising elemental metallic silver and elemental metallic ruthenium having an average particle size (d50) in the range of 1 to 100 μm, preferably 1 to 20 μm, and comprising a silver:ruthenium weight to in the range of 1 to 2000 parts by weight of silver: 1 part by weight of ruthenium or produced by a method according to claim 3 as an additive for the antimicrobial treatment of metal surfaces; coating agents; plasters; molding compounds; plastics in the form of plastics films, plastics parts or plastics fibers; textiles; textile applications; synthetic resin products; ion-exchange resins; silicone products; cellulose-based products; foams; and cosmetics.

11. A use of a carrierless bimetallic particulate material comprising elemental metallic silver and elemental metallic ruthenium having an average particle size (d50) in the range of 1 to 100 μm, preferably 1 to 20 μm, and comprising a silver:ruthenium weight ratio in the range of 1 to 2000 parts by weight of silver: 1 part by weight of ruthenium or produced by a method according to claim 3 as a heterogeneous catalyst in catalysis of the formation of hydroxyl radicals in aqueous media permitting bacterial growth.
